(19) United States
(12) Patent Application Publication
(10) Pub. No.: US 2025/0256793 A1
(43) Pub. Date: Aug. 14, 2025

(54) SYSTEM, ASSEMBLY DEVICE, AND MOVING OBJECT

(71) Applicant: TOYOTA JIDOSHA KABUSHIKI KAISHA, Toyota-sh (JP)

(72) Inventors: Kento IWAHORI, Nagoya-shi (JP); Daiki YOKOYAMA, Miyoshi-shi (JP); Yasuhiro SAITO, Toyoake-shi (JP)

(73) Assignee: TOYOTA JIDOSHA KABUSHIKI KAISHA, Toyota-shi (JP)

(21) Appl. No.: 19/037,418

(22) Filed: Jan. 27, 2025

(30) Foreign Application Priority Data
Feb. 14, 2024 (JP) 2024-020294

(51) Int. Cl. B62D 65/18; B62D 65/02

(52) U.S. Cl. CPC B62D 65/18; B62D 65/024

(57) ABSTRACT

The system includes a control command unit configured to transmit to a moving object running by unmanned driving a first control command for stopping the moving object at a first position, and a determination unit configured to determine whether a first stop position at which the moving object has been stopped according to the first control command is a work position suitable for the assembly of the part. When the determination unit determines that the first stop position is not the work position, the control command unit transmits to the moving object a second control command for moving the moving object to a second position where the assembly of the part is performed.

### CROSS-REFERENCE TO RELATED APPLICATIONS

This application claims priority to Japanese Patent Application No. 2024-20294 filed on Feb. 14, 2024, which is incorporated herein by reference in its entirety.

### BACKGROUND

### Field

The present disclosure relates to a system, an assembly device, and a moving object.

### Related Art

Japanese Translation of PCT International Application Publication No. 2017-538619 discloses a method for operating a vehicle running in a production system by remote control.

In a vehicle production step, as a method for producing a vehicle by assembling parts onto an uncompleted vehicle that is capable of running by unmanned driving, a method of stopping a running vehicle at a stop position to perform assembly may be performed. In this method, the vehicle may stop at a position displaced from the stop position. In this case, the assembly may not be performed properly. This problem is common to both vehicles and moving objects.

### SUMMARY

According to one aspect of the present disclosure, a system is provided. This system includes a control command unit that transmits to a moving object running by unmanned driving a first control command for stopping the moving object at a first position where assembly of a part is scheduled to be performed, and a determination unit that determines whether a first stop position at which the moving object has been stopped according to the first control command is a work position suitable for the assembly of the part. When the determination unit determines that the first stop position is not the work position, the control command unit transmits to the moving object a second control command for moving the moving object to a second position where the assembly of the part is performed.

### BRIEF DESCRIPTION OF THE DRAWINGS

FIG. 1 is a conceptual diagram showing a structure of a system;

FIG. 2 is a diagram describing stationary assembly;

FIG. 3 is a block diagram showing a structure of the system;

FIG. 4 is a block diagram showing a structure of an assembly robot;

FIG. 5 is a flowchart showing procedures in the process of running control of a vehicle;

FIG. 6 is a first flowchart showing procedures of stationary assembly control;

FIG. 7 is a second flowchart showing procedures of the stationary assembly control;

FIG. 8 is an explanatory view showing a schematic structure of a system according to a second embodiment; and

FIG. 9 is a flowchart showing procedures in the process of running control of a vehicle in the second embodiment.

### DETAILED DESCRIPTION

### A. First Embodiment

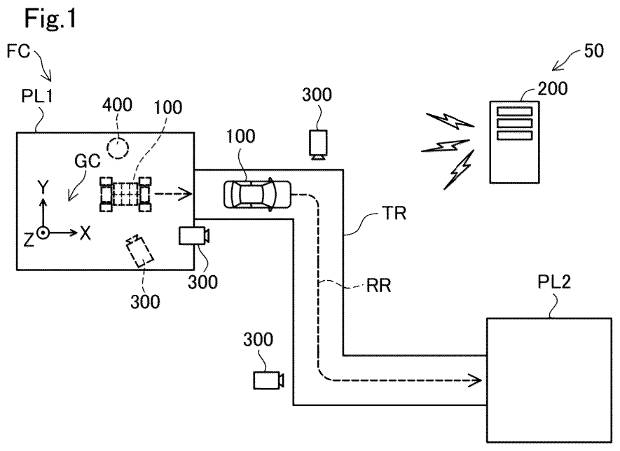

FIG. 1 is a conceptual diagram showing a structure of a system 50 in a first embodiment. The system 50 includes one or more vehicles 100 as moving objects, a server 200, one or more external sensors 300, and an assembly robot 400.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a truck, a bus, a two-wheel vehicle, a four-wheel vehicle, a combat vehicle, or a construction vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

In this embodiment, the system 50 is used in a factory FC that manufactures the vehicle 100. The reference coordinate system of the factory FC is a global coordinate system and a location in the factory can be expressed by X, Y, and Z coordinates in the global coordinate system GC. The factory FC has a first place PL1 and a second place PL2. The first place PL1 and the second place PL2 are connected by a runway TR on which the vehicle 100 can travel. The factory FC, along the runway TR, a plurality of external sensors 300 are installed. The position of the external sensors 300 in the shop FC is adjusted in advance. The vehicle 100 travel through the runway TR from the first place PL1 to the second place PL2 by unmanned operation.

In the present embodiment, at a first place PL1, an assembly step of a part PA is performed on the vehicle 100, which is in the form of a platform. Then, the vehicle 100 that has completed the assembly moves to a second place PL2 where the next step is performed. The vehicle 100, which is in the form of a platform, includes at least a vehicle control device 110, an actuator group 120, and a communication device 130, in order to perform the three functions, “running,” “turning,” and “stopping,” through unmanned driving.

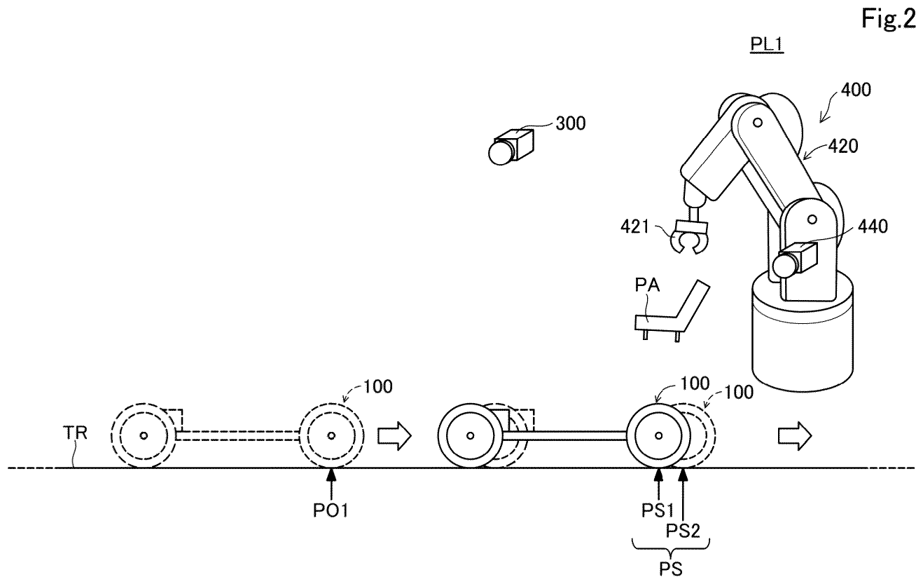

FIG. 2 is a diagram describing assembly of the part PA onto the vehicle 100 at the first place PL1. As shown in FIG. 2, an assembly robot 400 serving as an assembly device is disposed at the first place PL1 along a track TR of the vehicle 100. In the present disclosure, the track on which the vehicle 100 runs within the first place PL1 is also referred to as the track TR.

In the present embodiment, the assembly robot 400 is a vertical articulated robot. The assembly robot 400 includes an arm unit 420 and a robot sensor 440. An end effector 421 for gripping the part PA is attached to the top end portion of the arm unit 420.

The vehicle 100 runs by unmanned driving in the direction shown by the arrow in FIG. 2, and stops in the vicinity of the assembly robot 400. Then, the part PA is assembled by the assembly robot 400 onto the vehicle 100 which is in a stationary state. Such a method of assembling the part PA onto the vehicle 100 in the form of a stationary platform is also referred to as “stationary assembly”. In contrast, a method of assembling the part PA onto the vehicle 100 in the form of a moving platform, which is different from the present embodiment, is also referred to as “moving assembly”. The “stationary assembly” has an advantage that the accuracy required for the control of the vehicle 100 and the robot sensor 440 is often lower than the accuracy required in the “moving assembly.”

In the “stationary assembly,” a stop position PS of the vehicle 100 may deviate from the proper position. According to the present embodiment described below, the part PA can be assembled even when the stop position of the vehicle 100 deviates from the proper position.

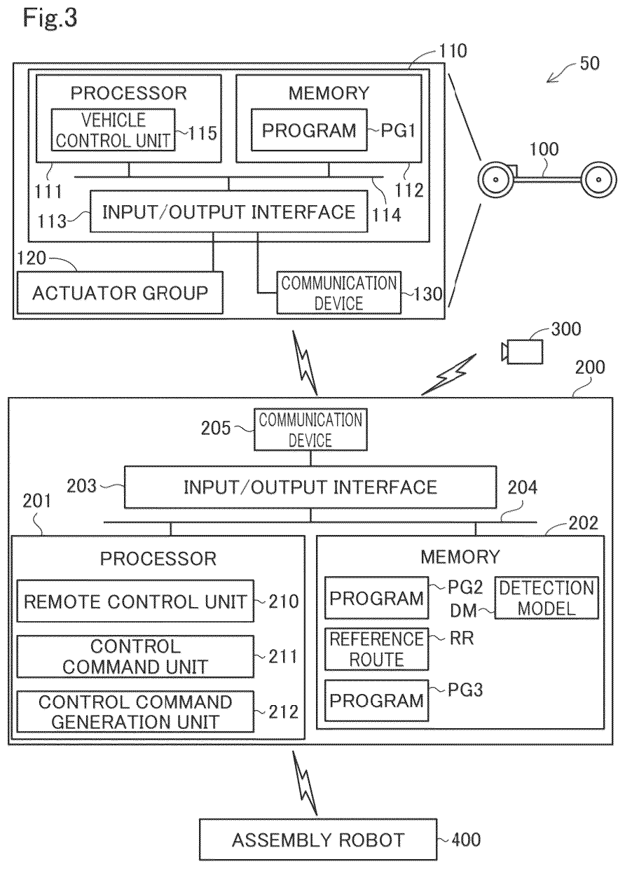

FIG. 3 is a block diagram showing the configuration of the system 50. The vehicle 100 includes a vehicle control device 110 for controlling the various parts of the vehicle 100, an actuator group 120 including one or more actuators driven under the control of the vehicle control device 110, and a communication device 130 for communicating by wireless communication with an external device such as a server 200. The actuator group 120 includes an actuator of a drive for accelerating the vehicle 100, an actuator of a steering system for changing the direction of travel of the vehicle 100, and an actuator of a braking system for decelerating the vehicle 100.

The vehicle control device 110 is constituted by a computer including a processor 111, a memory 112, I/O interface 113, and an internal bus 114. The processor 111, memory 112, and the I/O interface 113 are bidirectionally communicatively connected via an internal bus 114. An actuator group 120 and a communication device 130 are connected to the I/O interface 113. The processor 111 implements various functions, including functions as Vehicle control unit 115, by executing program PG1 stored in the memories 112.

Vehicle control unit 115, by controlling the actuator group 120, to run the vehicle 100. Vehicle control unit 115 by controlling the actuator group 120 using the travel control signal received from the server 200, it is possible to travel the vehicle 100. The travel control signal is a control signal for traveling the vehicle 100. In this embodiment, the travel control signal includes the acceleration and steering angle of the vehicle 100 as parameters. In other embodiments, the travel control signal may include the speed of the vehicle 100 as a parameter in lieu of or in addition to the acceleration of the vehicle 100.

The server 200 is comprised of a computer including a processor 201, a memory 202, an input/output interface 203, and an internal bus 204. The processor 201, memory 202, and I/O interface 203 are bidirectionally communicatively connected via an internal bus 204. The I/O interface 203 is connected to a communication device 205 for communicating with various devices external to the server 200. Communication device 205 may communicate with vehicle 100 via wireless communication and may communicate with each external sensor 300 via wired or wireless communication. The processor 201 executes the program PG2 stored in the memory 202 to realize various functions including functions as the remote control unit 210.

The remote control unit 210 acquires a detection result by the sensor, generates a travel control signal for controlling the actuator group 120 of the vehicle 100 using the detection result, and transmits a travel control signal to the vehicle 100, thereby causing the vehicle 100 to travel by remote control. The remote control unit 210 may generate and output not only a travel control signal but also a control signal for controlling various accessories provided in the vehicle 100 and actuators for operating various equipments such as a wiper, a power window, and a lamp. That is, the remote control unit 210 may operate such various equipments and various accessories by remote control.

In addition to the above structure, the processor 201 includes a control command unit 211 and a control command generation unit 212. In addition to the above structure, the memory 202 stores a program PG3. The control command unit 211 and the control command generation unit 212 are functional units implemented by executing the program PG3. The server 200 functions as a control device for controlling the vehicle 100 in the assembly step.

The external sensor 300 is a sensor located outside the vehicle 100. The external sensor 300 in this embodiment is a sensor for capturing the vehicle 100 from the outside of the vehicle 100. The external sensor 300 includes a communication device (not shown) and can communicate with other devices, such as the server 200, via wired or wireless communication.

Specifically, the external sensor 300 includes a camera. The camera as the external sensor 300 captures images of the vehicle 100 and outputs the captured images as detection results.

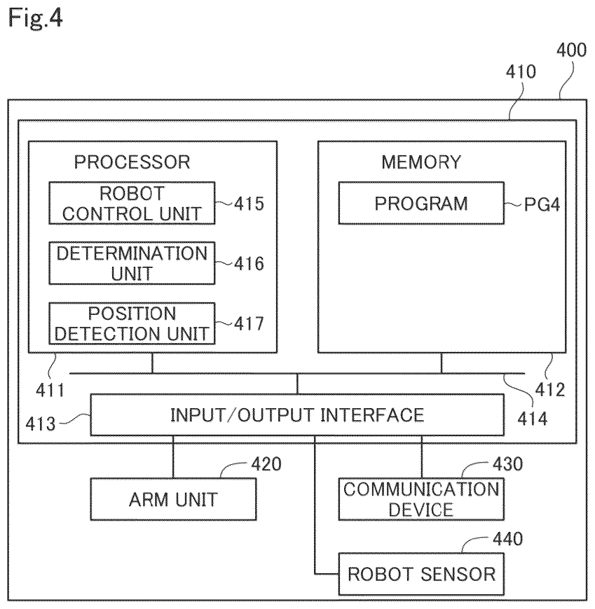

FIG. 4 is a block diagram showing a structure of the assembly robot 400. In addition to the above structure, the assembly robot 400 includes a robot control device 410 and a communication device 430.

The robot control device 410 includes a computer with a processor 411, a memory 412, an input/output interface 413, and an internal bus 414. The processor 411, the memory 412, and the input/output interface 413 are connected via the internal bus 414 to enable bidirectional communication. The arm unit 420, the communication device 430, and the robot sensor 440 are connected to the input/output interface 413.

In the present embodiment, the processor 411 functions as a robot control unit 415, a determination unit 416, and a position detection unit 417 by executing a program PG4 stored in advance in the memory 412. The robot control unit 415 controls each unit of the assembly robot 400, including the arm unit 420. The communication device 430 serving as the transmission unit and the reception unit is capable of communication with the server 200 and the assembly robot 400 via wired or wireless communication. The robot sensor 440 is a sensor that captures the vehicle 100 from outside of the vehicle 100. Specifically, the robot sensor 440 includes a camera. The camera as the robot sensor 440 captures images of the vehicle 100 and outputs the captured images as detection results.

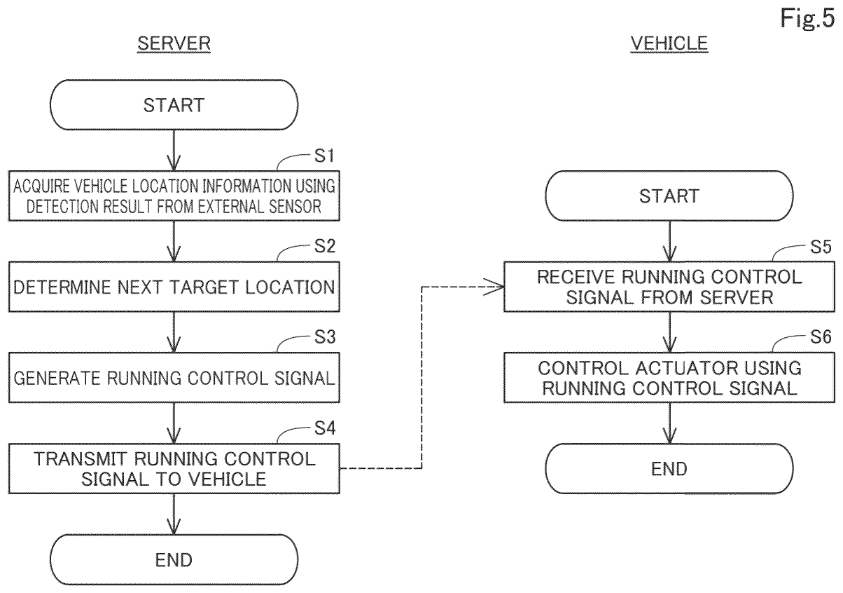

As described above, in the first place PL1, the vehicle 100 in the form of a platform runs by unmanned driving under the control of the server 200. The part PA is assembled onto the vehicle 100 stopped at the stop position PS. To describe this, running control by the server 200 is first described below with reference to FIG. 5.

FIG. 5 is a flowchart showing procedures in the process of running control of the vehicle 100. In the procedures of the process in FIG. 5, the processor 201 of the server 200 functions as a remote control unit 210 by executing a program PG2. Further, the processor 111 of the vehicle 100 functions as a vehicle control unit 115 by executing a program PG1.

In step S1, the processor 201 of the server 200 acquires the vehicle-position data using the detection data outputted from the external sensor 300. Vehicle position information is the underlying position information that generates a travel control signal. In the present embodiment, the vehicle position information includes the position and orientation of the vehicle 100 in the global coordinate system GC of the factory FC. Specifically, in step S1, the processor 201 acquires the vehicle position data using the captured images acquired from the cameras that are the external sensors 300.

More specifically, in step S1, the server 200 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system, thereby acquiring the location of the vehicle 100. The outer shape of the vehicle 100 in the captured image may be detected by inputting the captured image to a detection model using artificial intelligence, for example. The detection model is prepared in the system 50 or outside the system 50. The detection model is stored in advance in a memory of the server 200, for example. An example of the detection model is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model and the label. The server 200 can acquire the orientation of the vehicle 100 through estimation based on the direction of a motion vector of the vehicle 100 detected from change in location of a feature point of the vehicle 100 between frames of the captured images using optical flow process, for example.

In step S2, the server 200 determines a target location to which the vehicle 100 is to move next. In the present embodiment, the target location is expressed by X, Y, and Z coordinates in the global coordinate system. The memory of the server 200 contains a reference route stored in advance as a route along which the vehicle 100 is to run. The route is expressed by a node indicating a departure place, a node indicating a way point, a node indicating a destination, and a link connecting nodes to each other. The server 200 determines the target location to which the vehicle 100 is to move next using the vehicle location information and the reference route. The server 200 determines the target location on the reference route ahead of a current location of the vehicle 100.

In step S3, the server 200 generates a running control signal for causing the vehicle 100 to run toward the determined target location. In the present embodiment, the running control signal includes an acceleration and a steering angle of the vehicle 100 as parameters. The server 200 calculates a running speed of the vehicle 100 from transition of the location of the vehicle 100 and makes comparison between the calculated running speed and a target speed of the vehicle 100 determined in advance. If the running speed is lower than the target speed, the server 200 generally determines an acceleration in such a manner as to accelerate the vehicle 100. If the running speed is higher than the target speed as, the server 200 generally determines an acceleration in such a manner as to decelerate the vehicle 100. If the vehicle 100 is on the reference route, server 200 determines a steering angle and an acceleration in such a manner as to prevent the vehicle 100 from deviating from the reference route. If the vehicle 100 is not on the reference route, in other words, if the vehicle 100 deviates from the reference route, the server 200 determines a steering angle and an acceleration in such a manner as to return the vehicle 100 to the reference route. In other embodiments, the running control signal may include the speed of the vehicle 100 as a parameter instead of or in addition to the acceleration of the vehicle 100.

In step S4, the server 200 transmits the generated running control signal to the vehicle 100. The server 200 repeats the acquisition of vehicle location information, the determination of a target location, the generation of a running control signal, the transmission of the running control signal, and others in a predetermined cycle.

In step S5, the vehicle 100 receives the running control signal transmitted from the server 200. In step S6, the vehicle 100 controls an actuator of the vehicle 100 using the received running control signal, thereby causing the vehicle 100 to run at the acceleration and the steering angle indicated by the running control signal. The vehicle 100 repeats the reception of a running control signal and the control over the actuator in a predetermined cycle. According to the system 50 in the present embodiment, it becomes possible to move the vehicle 100 without using a transport unit such as a crane or a conveyor.

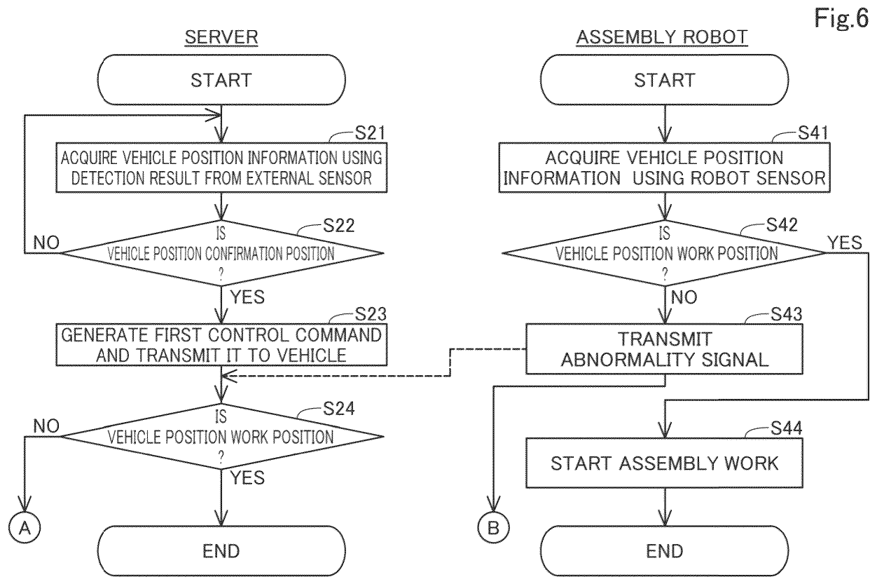

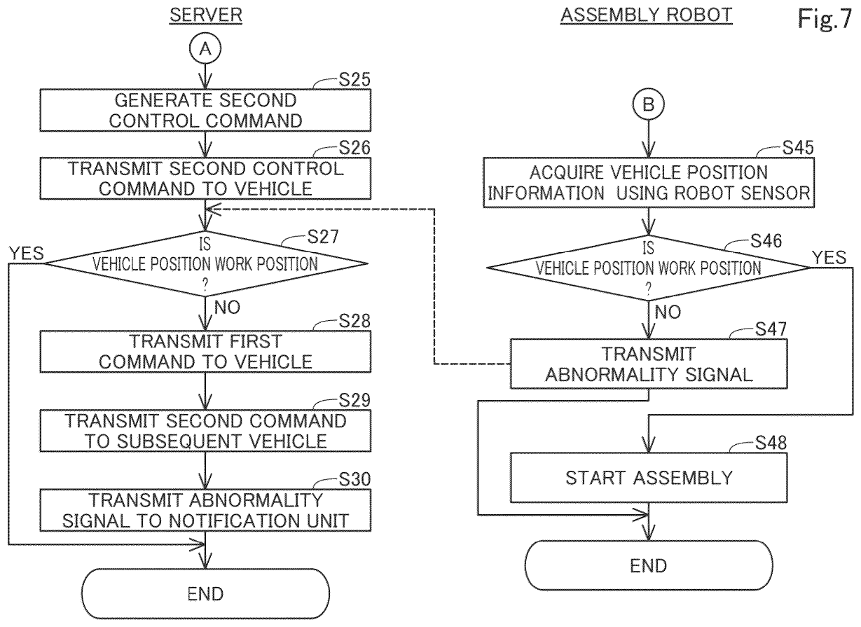

Next, the “stationary assembly” is described below with reference to FIG. 6 and FIG. 7. FIG. 6 is a first flowchart showing procedures of stationary assembly control. FIG. 7 is a second flowchart showing procedures of the stationary assembly control. The server 200 performs the running control shown in FIG. 5, and also performs the stationary assembly control. The stationary assembly control is used when the current position of the vehicle 100 reaches a confirmation position PO1, which is described later. During the “stationary assembly” control, the communication device 205 of the server 200 functions as a reception unit that receives first information, which is described later. During the “stationary assembly” control, the communication device 430 of the assembly robot 400 functions as the transmission unit.

In the step S21 of FIG. 6, as in the step S1, the control command unit 211 of the server 200 acquires vehicle position information using the detection results output from the external sensor 300. The vehicle position information includes the position and orientation of the vehicle 100 in a global coordinate system GC of a factory FC.

In the step S22, it is determined whether the vehicle position of the vehicle 100 indicated by the vehicle position information is the confirmation position PO1. As shown in FIG. 2, the confirmation position PO1 is an upstream position in the track TR relative to the stop position PS where the assembly by the assembly robot 400 is performed.

If it is determined in the step S22 of FIG. 6 that the vehicle position of the vehicle 100 is not the confirmation position PO1, the control command unit 211 returns the process to the step S21 after a predetermined time has elapsed. The predetermined time is, for example, several milliseconds. Here, the confirmation position PO1 designates position information used to determine whether the vehicle 100 is approaching the stop position PS. For this reason, the confirmation position PO1 may not be a point in the global coordinate system GC but may be defined including a position range.

If it is determined in the step S22 that the vehicle position is the confirmation position PO1, in the step S23, the control command unit 211 generates a first control command and transmits the first control command to the vehicle 100. The first control command is a signal that directs the vehicle 100 to stop at a first position PS1. In the present embodiment, the first control command is more specifically a running control signal set to stop the vehicle 100 at the first position PS1. The first position PS1 is the position where assembly of the part PA by the assembly robot 400 is scheduled. In the present embodiment, the first position PS1 is expressed in the form of X, Y, Z coordinates in the global coordinate system GC. As in the confirmation position PO1, the first position PS1 may not be a point in the global coordinate system GC but may be defined including a position range. This is because, even if the stop position PS of the vehicle 100 deviates from the optimal position for assembly work, the movement of the arm unit 420 of the assembly robot 400 enables the assembly work while compensating for the positional deviation.

Upon reception of the first control command, as in the step S6, the vehicle control unit 115 of the vehicle 100 controls the actuator group 120 so that the vehicle 100 stops at the first position PS1.

The assembly robot 400, when performing assembly work, first confirms whether the position of the stopped vehicle 100 is the proper work position for assembly. Specifically, first, in the step S41, the position detection unit 417 of the assembly robot 400 detects a first stop position, which is the stop position PS of the vehicle 100, using the robot sensor 440. In the present embodiment, the position acquired in the step S41 is the position of the vehicle 100 relative to the assembly robot 400. Since the step S41 is performed in the same manner as the step S1 performed by the server 200, the explanation of the step S41 is omitted.

Next, in the step S42, the determination unit 416 of the assembly robot 400 determines whether the first stop position at which the vehicle 100 has been stopped according to the first control command is the proper work position for the assembly of the part PA. If it is determined in the step S42 that the first stop position is not the work position, in the step S43, the robot control unit 415 transmits an abnormality signal as the first information to the server 200 via the communication device 430. The abnormality signal includes information indicating that the first stop position is not the work position. In the present embodiment, the first information further includes second information regarding positional deviation between the first stop position and the work position. In the present embodiment, the second information indicates whether the position of the vehicle 100 is behind or ahead of the work position. The abnormality signal is received by the communication device 205 of the server 200.

There are multiple causes why the first stop position is not the work position. Examples of the causes include the case where the vehicle position of the vehicle 100 calculated by the processor 201 of the server 200 using captured images, i.e., the estimation position, is deviated from the real position. Since the vehicle 100 runs according to the running control signal generated by the server 200, if the vehicle position as the starting point is deviated from the real position, the first stop position as the ending point will deviate from the first position PS1. Another cause why the first stop position is not the work position may be an error in the coordinates of the first position PS1 as the target position to which the vehicle 100 should go next.

The assembly robot 400, when far from the vehicle 100, has a posture that makes the assembly difficult due to the joint mechanism. Therefore, as described above, before the assembly work is performed, the assembly robot 400 determines whether the position of the vehicle 100 is the proper work position for the work using the robot sensor 440. For the same reason as that for the first position PS1, the work position may not be a point in the global coordinate system GC but may be defined including a position range.

If it is determined that the first stop position is the work position, in the step S44, the robot control unit 415 starts assembly work with respect to the vehicle 100 stopped at the first stop position. The robot control unit 415 performs the assembly work as a separate process routine.

In the step S24, the control command unit 211 determines whether the first stop position at which the vehicle 100 is stopped according to the first control command is the work position. If the abnormality signal transmitted in the step S43 has been received, the control command unit 211 determines that the first stop position is not the work position. On the other hand, if the abnormality signal transmitted in the step S43 has not been received, the control command unit 211 determines that the first stop position is the work position.

If it is determined in the step S24 that the first stop position is the work position, it is not necessary to further move the vehicle 100, and thus the control command unit 211 ends this process routine.

If it is determined in the step S24 that the first stop position is not the work position, in the step S25 of FIG. 7, the control command generation unit 212 generates a second control command. The second control command is a command for moving the vehicle 100 to a second position PS2 where assembly of the part PA is performed. In the present embodiment, the second control command includes control quantity information for remote control to the second position PS2. The control quantity information is information regarding control quantity, such as the steering angle and the acceleration, and serves as a command to be given to the vehicle 100 to enable the vehicle 100 to reach the second position PS2 from the first stop position.

In the step S26, the control command unit 211 transmits the generated second control command to the vehicle 100 via the communication device 205. In addition, in the step S26, the control command unit 211 transmits at least one of a deceleration command and a stop command to the subsequent vehicle 100 in the track TR of the vehicle 100 that has transmitted the second control command.

The second position PS2 is different from the first stop position. In the present embodiment, the second position PS2 is defined relative to the first stop position. In the present embodiment, the second position PS2 is away from the first position PS1 by a predetermined distance to the front or the back of the vehicle 100. In the present embodiment, the abnormality signal includes information regarding positional deviation as to whether the first stop position is behind or ahead of the work position. Therefore, the control command generation unit 212 determines the movement direction of the vehicle 100 in the second control command using the information regarding positional deviation included in the abnormality signal. In other words, if information indicating that the first stop position is behind the work position is included in the abnormality signal, the movement direction directed by the second control command is frontward. The second control command directs a control of moving, for example, 50 cm forward.

After the vehicle 100 moves according to the second control command, the assembly robot 400 attempts to assemble the part PA again. Specifically, first, in the step S45, as in the step S41, the position detection unit 417 of the assembly robot 400 detects the stop position PS of the vehicle 100 using the robot sensor 440.

The step S45 is a process step for determining whether the second stop position, which is the position of the vehicle 100 that has moved according to the second control command, is the work position. Therefore, in the step S25, the server 200 may transmit to the assembly robot 400 a signal indicating that the second control command has been transmitted to the vehicle 100. Then, the process may proceed such that the robot control unit 415 performs the step S45 after the signal indicating that the second control command has been transmitted to the vehicle 100 is received.

In the step S46, the determination unit 416 of the assembly robot 400 determines whether the second stop position at which the vehicle 100 has been stopped according to the second control command is the proper work position for assembling the part PA. If the determination unit 416 determines in the step S46 that the vehicle position is the work position, in the step S48, the robot control unit 415 starts the assembly work and ends this process routine.

If the determination unit 416 determines in the step S46 that the second stop position is not the work position, in the step S47, as in the step S45, the robot control unit 415 transmits an abnormality signal to the server 200 and ends this process routine.

In the step S27, as in the step S24, the control command unit 211 determines whether the second stop position is the work position. If the abnormality signal transmitted in the step S47 has been received, the control command unit 211 determines that the second stop position is not the work position. On the other hand, if the abnormality signal transmitted in the step S47 has not been received, the control command unit 211 determines that the second stop position is the work position.

If it is determined in the step S27 that the second stop position is the work position, it is not necessary to further move the vehicle 100, and thus the control command unit 211 ends this process routine.

If it is determined in the step S27 that the second stop position is not the work position, in the step S28, the control command unit 211 generates a first command that keeps the vehicle 100 stopped at the second stop position and transmits the first command to the vehicle 100 stopped at the second stop position.

In the step S29, the control command unit 211 performs a process of transmitting a second command for decelerating or stopping the subsequent vehicle 100, which is a vehicle subsequent to the vehicle 100 stopped at the second stop vehicle position.

In the step S30, the control command unit 211 performs a transmission process of transmitting an abnormality signal to a notification unit (not shown) that reports an abnormality. Specifically, the notification unit is, for example, a warning device for sounding alarms located at the first place PL1, or an information terminal device used by the administrator. If the notification unit is a warning device, the warning device sounds an alarm upon reception of the abnormality signal. Further, if the notification unit is an information terminal, the information terminal shows a message informing the abnormality on a display screen upon reception of the abnormality signal.

The case where it is determined that the second stop position is not the work position in the step S27 described above is a case where the vehicle 100 stopped at the first stop position has moved further, but the assembly work cannot be started. In this case, it is often more efficient if a worker addresses the abnormality. Therefore, in the present embodiment, the abnormality can be quickly resolved by performing the steps S28, S29, and S30. The order of performing the process steps of the steps S28, S29, and S30 is not limited to the order shown in FIG. 7. Further, as an alternative embodiment, at least one of the steps S28, S29, and S30 may be performed.

Further, in addition to the timing before the assembly robot 400 starts the assembly, an abnormality may also occur after the assembly has started in the steps S44 and S48. In this case as well, the control command unit 211 can perform the steps S27, S28, and S29. This allows for quick resolution of the abnormality. More specifically, the robot control unit 415 grips the part PA with the end effector 421 during the assembly work, and assembles the part PA onto the stopped vehicle 100. Examples of the abnormalities during the assembly work include an inability to grip the part PA and an inability to assemble the gripped part PA. Examples of the causes of the inability to assemble the gripped part PA include an abnormality in the orientation of the part PA before the part PA is gripped, an abnormality in the orientation of the gripped part PA, and an abnormality in the relative position between the vehicle 100 and the assembly robot 400. In this embodiment, the robot control unit 415 transmits an abnormality signal to the server 200 if an abnormality occurs during the assembly work. Upon reception of the abnormality signal, the control command unit 211 performs the steps S27, S28, and S29.

According to the first embodiment described above, the system 50 includes the control command unit 211 and the determination unit 416. If the determination unit 416 determines that the first stop position is not the proper work position for the assembly, in the step S26, the control command unit 211 transmits to the vehicle 100 the second control command to move the vehicle 100 to the second position PS2. This allows the control command unit 211 to move the vehicle 100 to the second position PS2, thereby enabling the assembly of the part PA at the second position PS2, even when the vehicle 100 stops at a position that is not the proper work position for the assembly of the part PA.

Further, the server 200 includes the control command unit 211. The assembly robot 400 includes the determination unit 416. This allows the assembly robot 400 to determine whether the position at which the vehicle 100 has been stopped is the work position, thereby allowing the server 200 to transmit the second control command to the vehicle 100.

Further, the assembly robot 400 includes the communication device 430 that transmits to the server 200 an abnormality signal indicating that the first stop position is not the work position. If the communication device 205 receives an abnormality signal, the control command unit 211 transmits the second control command in the step S26. This allows the server 200 to transmit the second control command when the assembly robot 400 transmits an abnormality signal.

Further, the abnormality signal indicating that the first stop position is not the work position includes information regarding positional deviation. This allows the control command generation unit 212 to generate the second control command by reflecting the information regarding positional deviation. This makes it possible to move the vehicle 100 to the suitable position for assembly of the part.

Further, the server 200 has the control command generation unit 212 that generates the second control command including the control quantity information for remote control to the second position PS2. This allows the control command generation unit 212 to generate the second control command that includes the control quantity information.

Further, the assembly robot 400 performs assembly of the part PA onto the vehicle 100 that has been stopped according to the second control command. This allows the assembly robot 400 to perform assembly of the part PA onto the vehicle 100 that has been stopped according to the second control command. Further, the assembly robot 400 performs assembly of the part PA onto the vehicle 100 stopped at the first position PS1. This allows the assembly robot 400 to perform assembly of the part PA onto the vehicle 100 that has been stopped according to the first control command.

Further, if the determination unit 416 determines that the first stop position is not the work position, in the step S26, the control command unit 211 transmits at least one of the deceleration command and the stop command to the vehicle 100 subsequent to the stopped vehicle 100. This allows to maintain an appropriate distance between the stopped vehicle 100 and the subsequent vehicle 100.

Further, if the determination unit 416 determines that the second stop position at which the vehicle 100 has been stopped according to the second control command is not the work position, the control command unit 211 performs the steps S28, S29, and S30. This allows the steps S28, S29, and S30 to be performed when the assembly cannot be properly performed onto the vehicle 100 stopped at the second stop position. This allows to maintain an appropriate distance between the stopped vehicle 100 and the subsequent vehicle 100. In addition, the abnormality can be resolved quickly by workers.

### B. Second Embodiment

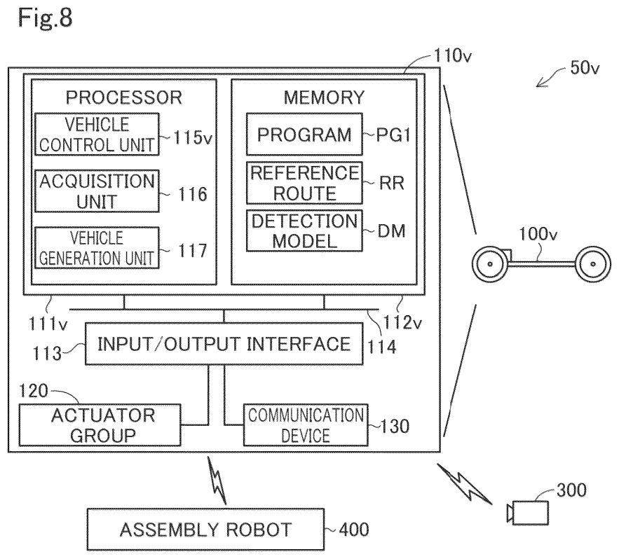

FIG. 8 is an explanatory diagram illustrating a schematic configuration of a system 50v according to a second embodiment. In this embodiment, 50v differs from that of the first embodiment in that it does not include the servers 200. Further, the vehicle 100v in the present embodiment can be traveled by autonomous control of the vehicle 100v. For other configurations, unless otherwise described, it is the same as the first embodiment.

In the present embodiment, the processor 111v of the vehicle controller 110v functions as the vehicle controller 115v by executing the programmed PG1 stored in the memorized 112v. The vehicle control unit 115v acquires an output result by the sensor, generates a travel control signal using the output result, and outputs the generated travel control signal to operate the actuator group 120, thereby allowing the vehicle 100v to travel by autonomous control. In the present embodiment, in addition to the programming PG1, the detection-model DM and the reference-path RR are stored in the memory 112v in advance.

The processor 111v further includes an acquiring unit 116 and a vehicle creating unit 117 serving as a moving object creating unit. The processor 111v of the vehicle control device 110v functions as the acquiring unit 116 and the vehicle creating unit 117 by executing the program PG1 stored in the memory 112v.

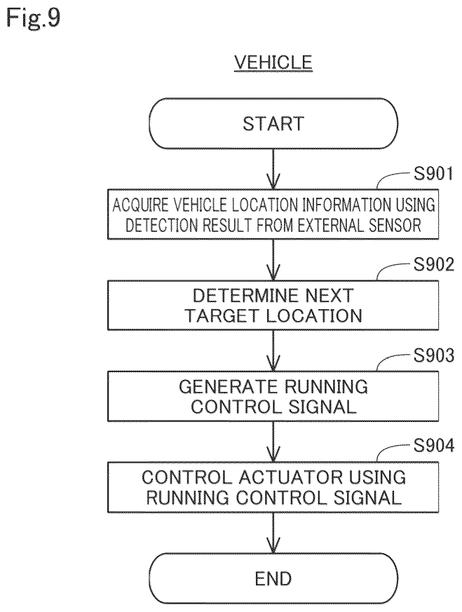

FIG. 9 is a flow chart showing a process sequence of the traveling control of the vehicular 100v in the second embodiment. In the process of FIG. 9, the processor 111v of the vehicle 100v functions as a vehicle controller 115v by executing a programmed PG1.

In step S901, the processor 111v of the vehicle controller 110v acquires vehicle location information using detection result output from the camera as an external sensor. In step S902, the processor 111v determines a target location to which the vehicle 100v is to move next. In step S903, the processor 111v generates a running control signal for causing the vehicle 100v to run to the determined target location. In step S904, the processor 111v controls an actuator using the generated running control signal, thereby causing the vehicle 100v to run by following a parameter indicated by the running control signal. the processor 111v repeats the acquisition of vehicle location information, the determination of a target location, the generation of a running control signal, and the control over the actuator in a predetermined cycle. According to the running control in the present embodiment, it is possible to cause the vehicle 100v to run by autonomous control without controlling the vehicle 100v remotely using the server 200.

The procedures of “stationary assembly” according to the present embodiment is described below in terms of the differences from those in the first embodiment. In the first embodiment, when the first stop position is not the work position, the vehicle 100 moves to the second position PS2 according to the second control command transmitted from the server 200. In contrast, in the present embodiment, the vehicle 100 generates a control signal to move itself to the second position PS2.

More specifically, if the stop position at which the vehicle 100 has been stopped for assembly is not the work position, the acquisition unit 116 acquires information regarding the positional deviation between the stop position and the work position. Specifically, for example, the acquisition unit 116 acquires information regarding the positional deviation between the stop position and the work position from the assembly robot 400.

In the present embodiment, examples of the causes why the stop position is not the work position include the case where the vehicle position information acquired by a processor 111v of a vehicle control device 110v is deviated from the real position.

A vehicle generation unit 117 generates control information for stopping the vehicle at the work position using information acquired by the acquisition unit 116. The control information includes the same information as that included in the running control signal described above. A vehicle control unit 115v as the control unit controls the actuator included in the actuator group 120 according to the control information. This allows a vehicle 100v to move to the second position PS2 without the second control command from the server 200.

### C. Alternative Embodiments (Alternative Embodiments With Regard to Assembly)

(C1) In the first embodiment described above, the second control command transmitted in the step S26 directs movement by a predetermined distance to the front or the back of the vehicle 100. In an alternative embodiment, information regarding the distance between the first stop position and the work position may be included as the second information. In this embodiment, the determination unit 416 of the assembly robot 400 generates the information regarding the distance between the first stop position and the work position as the second information. Then, the control command generation unit 212 generates a second control command including the movement direction and movement distance using the second information. Further, the second control command may include the movement direction, which also includes the left/right direction calculated from the second information, and the movement distance. As the quantity of information directed by the second control command increases, the vehicle 100 can be more accurately guided to the work position. As the quantity of information directed by the second control command decreases, the load of calculation performed by the determination unit 416 of the assembly robot 400 and the load of calculation performed by the control command generation unit 212 can be reduced.
(C2) In the first embodiment described above, the second control command transmitted in the step S26 directs movement by a predetermined distance to the front or the back of the vehicle 100. In an alternative embodiment, the second control command may include, instead of the predetermined distance, a distance calculated from the distance between the first stop position and the work position included in the second information. In this case, the control command generation unit 212 may generate the second control command on the premise that the assembly robot 400 addresses the positional deviation in the left/right direction of the vehicle 100 and that the vehicle 100 is moved only in the front/back direction. The vehicle 100 is difficult to move in the left/right direction. Therefore, generating the second control command that causes the vehicle 100 to move only in the front/back direction can reduce the movement time of the vehicle 100 from the first stop position to the second position.
(C3) In the first embodiment described above, in the step S25, the second control command generated by the control command generation unit 212 includes control information for remote control to the second position PS2. In an alternative embodiment, the second control command generated by the control command generation unit 212 may include route information regarding the route to the second position PS2. Further, the second control command may include both the route information and the control quantity information. In the case where the second control command includes the route information, the vehicle control unit 115 uses the route information to control the actuator group 120 so that the vehicle 100 runs along the route.
(C4) In the first embodiment described above, the assembly robot 400 is a vertical articulated robot. The assembly robot 400 is not limited to vertical articulated robots, but may be another kind of robot, for example, a horizontal articulated robot.
(C5) In the first embodiment described above, the robot sensor 440 is a camera. The robot sensor 440 is not limited to cameras, but may be, for example, a distance measuring device. The distance measuring device is, for example, a LIDAR (Light Detection And Ranging). In this case, the detection result output by the robot sensor 440 may be 3D point cloud data representing the vehicle 100. In this case, the position detection unit 417 may acquire the vehicle position information by template matching using the 3D point cloud data as the detection result and the reference point cloud data prepared in advance.
(C6) In the step S42 of the first embodiment described above, if the cause why the position of the vehicle 100 is not the work position is because of an error in the coordinates of the first position PS1 directed by the control command unit 211, it is assumed that the transmission of abnormality signals in the step S43 will occur frequently. Therefore, the server 200 may be configured to count the frequency of the execution of the step S43, and perform the steps S28, S29, and S30 if the frequency exceeds a predetermined reference value. This allows for quick resolution of the abnormality.
(C7) In the first embodiment described above, the determination unit 416 is included in the assembly robot 400. In an alternative embodiment, the server 200 may include a determination unit. In this case, the determination unit of the server 200 may perform the determination using a detection signal from the external sensor 300 or an abnormality signal transmitted from the assembly robot 400. Further, in the first embodiment described above, the control command unit 211 includes the server 200. In an alternative embodiment, the assembly robot 400 may include the control command unit 211.
(C8) In the first embodiment described above, in the step S26, at least one of the deceleration command and the stop command is performed. In an alternative embodiment, neither the deceleration command nor the stop command may be performed in the step S26. Further, in the first embodiment described above, if it is determined in the step S27 that the second stop position is not the work position, the steps S28, S29, and S30 are performed. In an alternative embodiment, none of the steps S28, S29, and S30 may be performed.
(C9) In the first embodiment described above, the abnormality signal as the first information includes information regarding positional deviation as the second information. In an alternative embodiment, the abnormality signal may not include the information regarding positional deviation. As described above, the cases where the first stop position is not the work position include a case where there is an error in the coordinates of the first position PS1 directed by the control command unit 211. In this case, the robot sensor 440 may fail to detect the vehicle 100. In this case, it may be configured such that the abnormality signal does not include the information regarding positional deviation, but includes the information indicating that the first stop position is not the work position. Further, it may be configured such that the abnormality signal includes the information regarding positional deviation if the vehicle 100 can be detected by the robot sensor 440, and that the abnormality signal does not include the information regarding positional deviation if the vehicle 100 cannot be detected by the robot sensor 440.
(C10) In the first embodiment described above, the second control command includes a command that directs the forward or backward movement direction determined based on the information regarding positional deviation. In an alternative embodiment, the second control command may direct movement in a predetermined direction. Depending on the orientation of the arm unit 420 of the assembly robot 400, the assembly work may become possible by moving the vehicle 100 neither frontward nor backward. In this case, transmitting a predetermined second control command without calculation by the control command generation unit 212 can reduce the load of calculation on the control command generation unit 212.
(C11) In the first embodiment described above, the position acquired in the step S41 is the position of the vehicle 100 relative to the assembly robot 400. This relative position is not limited to a precise position convertible into coordinates in the global coordinate system GC, but may be approximate position information. The approximate information is, for example, information indicating whether the stop position PS of the vehicle 100 is ahead or behind the work position. Further, the position acquired in the step S41 may not be the relative position but may be coordinates in the global coordinate system GC.
(C12) In the first embodiment described above, the second position PS2 is defined based on the relative position with respect to the first stop position. In an alternative embodiment, the second position PS2 may be coordinates in the global coordinate system GC.

### D. Alternative Embodiments (Alternative Embodiments With Regard to Remote Control auto Driving System)

(D1) In each of the above-described embodiments, the external sensor is not limited to the camera but may be the distance measuring device, for example. The distance measuring device is a light detection and ranging (LiDAR) device, for example. In this case, detection result output from the external sensor may be three-dimensional point cloud data representing the vehicle 100. The server 200 and the vehicle 100 may acquire the vehicle location information through template matching using the three-dimensional point cloud data as the detection result and reference point cloud data, for example.
(D2) In the above-described first embodiment, the server 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.
(1) The server 200 may acquire vehicle location information, determine a target location to which the vehicle 100 is to move next, and generate a route from a current location of the vehicle 100 indicated by the acquired vehicle location information to the target location. The server 200 may generate a route to the target location between the current location and a destination or generate a route to the destination. The server 200 may transmit the generated route to the vehicle 100. The vehicle 100 may generate a running control signal in such a manner as to cause the vehicle 100 to run along the route received from the server 200 and control an actuator using the generated running control signal.
(2) The server 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control an actuator using the generated running control signal.
(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the server 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.
(D3) In the above-described embodiment in which the vehicle 100v can be running by autonomous control, the vehicle 100v may be equipped with an internal sensor, and detection result output from the internal sensor may be used in at least one of generation of a route and generation of a running control signal. For example, the vehicle 100v may acquire detection result from the internal sensor, and in generating the route, may reflect the detection result from the internal sensor in the route. The vehicle 100v may acquire detection result from the internal sensor, and in generating the running control signal, may reflect the detection result from the internal sensor in the running control signal.
(D4) In the above-described embodiment in which the vehicle 100v can be running by autonomous control, the vehicle 100v acquires vehicle location information using detection result from the external sensor. By contrast, the vehicle 100v may be equipped with an internal sensor, the vehicle 100v may acquire vehicle location information using detection result from the internal sensor, determine a target location to which the vehicle 100v is to move next, generate a route from a current location of the vehicle 100v indicated by the acquired vehicle location information to the target location, generate a running control signal for running along the generated route, and control an actuator of the vehicle 100v using the generated running control signal. In this case, the vehicle 100v is capable of running without using any detection result from an external sensor. The vehicle 100v may acquire target arrival time or traffic congestion information from outside the vehicle 100v and reflect the target arrival time or traffic congestion information in at least one of the route and the running control signal. The functional configuration of the system 50v may be entirely provided at the vehicle 100v. Specifically, the processes realized by the system 50v in the present disclosure may be realized by the vehicle 100v alone.
(D5) In the above-described first embodiment, the server 200 automatically generates a running control signal to be transmitted to the vehicle 100. By contrast, the server 200 may generate a running control signal to be transmitted to the vehicle 100 in response to operation by an external operator existing outside the vehicle 100. For example, the external operator may operate an operating device including a display on which a captured image output from the external sensor is displayed, steering, an accelerator pedal, and a brake pedal for operating the vehicle 100 remotely, and a communication device for making communication with the server 200 through wire communication or wireless communication, for example, and the server 200 may generate a running control signal responsive to the operation on the operating device.
(D6) In each of the above-described embodiments, the vehicle 100 is simply required to have a configuration to become movable by unmanned driving. The vehicle 100 may embodied as a platform having the following configuration, for example. The vehicle 100 is simply required to include at least actuators and a controller. More specifically, in order to fulfill three functions including “run,” “turn,” and “stop” by unmanned driving, the actuators may include a driving device, a steering device and a braking device. The actuators are controlled by the controller that controls running of the vehicle 100. In order for the vehicle 100 to acquire information from outside for unmanned driving, the vehicle 100 is simply required to include the communication device further. Specifically, the vehicle 100 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100 before the vehicle 100 is shipped from a factory, or a remaining component such as a bodyshell may be mounted on the vehicle 100 after the vehicle 100 is shipped from a factory while the remaining component such as a bodyshell is not mounted on the vehicle 100. Each of components may be mounted on the vehicle 100 from any direction such as from above, from below, from the front, from the back, from the right, or from the left. Alternatively, these components may be mounted from the same direction or from respective different directions. The location determination for the platform may be performed in the same way as for the vehicle 100 in the first embodiments.
(D7) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.
(D8) A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.
(D9) In each of the above embodiments, some or all of the functions and processing implemented in software may be implemented in hardware. In addition, some or all of the functions and processes implemented in hardware may be implemented in software. As hardware for realizing various functions in the above embodiments, for example, it may be used various circuits such as integrated circuits and discrete circuits.

The present disclosure is not limited to the embodiments described above, but can be realized in various configurations without departing from the spirit thereof. Further, if the technical feature is not described as essential in this specification, the technical feature may be deleted as appropriate. For example, the present disclosure may be implemented by the aspects described below.
(1) According to a first aspect of the present disclosure, a system is provided. This system includes a control command unit configured to transmit to a moving object running by unmanned driving a first control command for stopping the moving object at a first position where assembly of a part is scheduled to be performed, and a determination unit configured to determine whether a first stop position at which the moving object has been stopped according to the first control command is a work position suitable for the assembly of the part. When the determination unit determines that the first stop position is not the work position, the control command unit transmits to the moving object a second control command for moving the moving object to a second position where the assembly of the part is performed. According to the above aspect, even when the moving object stops at a position that is not the proper work position for the assembly of the part, it is possible to enable the assembly of the part at the second position by moving the moving object to the second position by the control command unit.
(2) The system according to the above aspect may include a control device including the control command unit, and an assembly device that performs the assembly of the part. The assembly device includes the determination unit. According to the above aspect, the assembly device can determine whether the position where the moving object has been stopped is the work position, and the control device can transmit the second control command to the moving object.
(3) In the system according to the above aspect, the assembly device may further include a transmission unit configured to transmit to the control device first information indicating that the first stop position is not the work position when the determination unit determines that the first stop position is not the work position, the control device may further include a reception unit configured to receive the first information, and the control command unit may transmit the second control command when the reception unit receives the first information. According to the above aspect, the control device can transmit the second control command when the assembly device transmits the first information.
(4) In the system according to the above aspect, the first information may include second information regarding positional deviation between the first stop position and the work position. According to the above aspect, the assembly device can transmit the information regarding positional deviation to the control device. This allows the moving object to move to the position suitable for the assembly of the part.
(5) In the system according to the above aspect, the control device may further include a control command generation unit configured to generate, using the second information, the second control command that includes at least one of route information regarding a route to the second position and control quantity information for remote control to the second position. According to the above aspect, it is possible to generate the second control command that includes either the route information or the control quantity information generated by the control command generation unit.
(6) The system according to the above aspect may further include an assembly device that performs the assembly of the part. The assembly device may perform the assembly of the part on the moving object that has been moved according to the second control command. According to the above aspect, the assembly device can perform the assembly of the part onto the moving object that has been stopped according to the second control command.
(7) The system according to the above aspect may further include an assembly device that performs the assembly of the part. When the determination unit determines that the first stop position is the work position, the assembly device may perform the assembly of the part on the moving object stopped at the first stop position. According to the above aspect, the assembly device can perform the assembly of the part onto the moving object stopped at the moving object stop position.
(8) In the system according to the above aspect, when the determination unit determines that the first stop position is not the work position, at least one of a deceleration command and a stop command may be transmitted to a moving object subsequent to the moving object stopped at the first stop position. According to the above aspect, it is possible to keep an appropriate distance between the moving object stopped at the moving object stop position and the subsequent moving object.
(9) In the system according to the above aspect, the determination unit may determine whether a second stop position where the moving object has been stopped according to the second control command is the work position, and, when the determination unit determines that the second stop position is not the work position, the control command unit may perform at least one of a process of transmitting a first command for keeping the moving object stopped at the second stop position, a process of transmitting a second command for deceleration or stopping to a moving object subsequent to the moving object stopped at the second stop position, and a process of transmitting an abnormality signal to a notification unit that notifies an abnormality. According to the above aspect, when the second stop position is not the work position, that is, when the assembly cannot be properly performed onto the moving object stopped at the second stop position, one of the process of transmitting the first command, the process of transmitting the second command, and the process of transmitting the abnormality signal may be performed.
(10) According to a second aspect of the present disclosure, an assembly device that performs assembly of a part onto a moving object is provided. The assembly device includes a transmission unit configured to communicate with at least one of the moving object and a control device that performs remote control with respect to the moving object, a position detection unit configured to detect a stop position of the moving object, and a determination unit configured to determine whether the stop position is a work position suitable for the assembly of the part. The transmission unit transmits information regarding positional deviation between the stop position and the work position to at least one of the control device and the moving object when the determination unit determines that the stop position is not the work position. According to the above aspect, it is possible to provide an assembly device that transmits information regarding positional deviation between the stop position and the work position when it is determined that the position where the moving object is stopped is not the proper work position for the assembly.
(11) According to a third aspect of the present disclosure, a moving object is provided. The moving object includes an acquisition unit configured to acquire information regarding positional deviation between a stop position of the moving object and a work position suitable for assembly of a part onto the moving object, a moving object generation unit configured to generate control information for stopping the moving object at the work position using the acquired information, and a control unit configured to control an actuator for causing the moving object to run using the control information. According to the above aspect, it is possible to provide a moving object that moves to a proper work position for assembly when the position where the moving object is stopped is not the proper work position for the assembly.

The present disclosure may also be implemented in various aspects other than the aspects described above. For example, the present disclosure may also be implemented in aspects including an assembly method, a program for assembly method, a non-transitory tangible computer-readable storage medium storing the program for assembly.

What is claimed is:

1. A system comprising:
a control command unit configured to transmit to a moving object running by unmanned driving a first control command for stopping the moving object at a first position where assembly of a part is scheduled to be performed; and
a determination unit configured to determine whether a first stop position at which the moving object has been stopped according to the first control command is a work position suitable for the assembly of the part,
wherein, when the determination unit determines that the first stop position is not the work position, the control command unit transmits to the moving object a second control command for moving the moving object to a second position where the assembly of the part is performed.

2. The system according to claim 1, comprising:
a control device comprising the control command unit; and
an assembly device that performs the assembly of the part, the assembly device comprising the determination unit.

3. The system according to claim 2, wherein
the assembly device further comprises a transmission unit configured to transmit to the control device first information indicating that the first stop position is not the work position when the determination unit determines that the first stop position is not the work position,
the control device further comprises a reception unit configured to receive the first information, and
the control command unit transmits the second control command when the reception unit receives the first information.

4. The system according to claim 3, wherein
the first information includes second information regarding positional deviation between the first stop position and the work position.

5. The system according to claim 4, wherein
the control device further comprises a control command generation unit configured to generate, using the second information, the second control command that includes at least one of route information regarding a route to the second position and control quantity information for remote control to the second position.

6. The system according to claim 1, further comprising
an assembly device that performs the assembly of the part,
wherein the assembly device performs the assembly of the part on the moving object that has been moved according to the second control command.

7. The system according to claim 1, further comprising
an assembly device that performs the assembly of the part,
wherein, when the determination unit determines that the first stop position is the work position, the assembly device performs the assembly of the part on the moving object stopped at the first stop position.

8. The system according to claim 1, wherein
when the determination unit determines that the first stop position is not the work position, at least one of a deceleration command and a stop command is transmitted to a moving object subsequent to the moving object stopped at the first stop position.

9. The system according to claim 1, wherein
the determination unit determines whether a second stop position where the moving object has been stopped according to the second control command is the work position, and
when the determination unit determines that the second stop position is not the work position, the control command unit performs at least one of a process of transmitting a first command for keeping the moving object stopped at the second stop position, a process of transmitting a second command for deceleration or stopping to a moving object subsequent to the moving object stopped at the second stop position, and a process of transmitting an abnormality signal to a notification unit that notifies an abnormality.

10. An assembly device that performs assembly of a part onto a moving object, comprising:
a transmission unit configured to communicate with at least one of the moving object and a control device that performs remote control with respect to the moving object;
a position detection unit configured to detect a stop position of the moving object; and
a determination unit configured to determine whether the stop position is a work position suitable for the assembly of the part,
wherein the transmission unit transmits information regarding positional deviation between the stop position and the work position to at least one of the control device and the moving object when the determination unit determines that the stop position is not the work position.

11. A moving object, comprising:
an acquisition unit configured to acquire information regarding positional deviation between a stop position of the moving object and a work position suitable for assembly of a part onto the moving object;
a moving object generation unit configured to generate control information for stopping the moving object at the work position using the acquired information; and
a control unit configured to control an actuator for causing the moving object to run using the control information.
